(19) United States
(12) Patent Application Publication
(10) Pub. No.: US 2022/0187464 A1
(43) Pub. Date: Jun. 16, 2022

(54) INDOOR SURVEYING APPARATUS AND METHOD

(71) Applicant: Planitar Inc., Kitchener (CA)

(72) Inventor: Alexander Likholyot, Kitchener (CA)

(21) Appl. No.: 17/274,346

(22) PCT Filed: May 26, 2020
(86) PCT No.: PCT/CA2020/050714

§ 371 Date: Mar. 8, 2021

(51) Int. Cl. G01S 17/89; G06V 20/50; G06V 10/74; G01S 17/48

(52) U.S. Cl. CPC G01S 17/89; G01S 17/48; G06V 10/74; G06V 20/50

(57) ABSTRACT

An apparatus for, or method of, applying an automated projection algorithm to project at least one 2D emission pattern onto a horizontal plane to generate a map of an environment, applying an automated object recognition algorithm to at least one image to recognize at least one feature, the at least one feature being at least one of a doorway, a mirror, and a window of the environment, applying an automated matching algorithm to the at least one image and the at least one 2D emission pattern using at least one set of configuration data to determine a feature position of the at least one feature on the map; and marking the map to indicate the feature position of the at least one feature.

### FIELD

The specification relates generally to apparatuses and methods for mapping an environment, and more specifically to mapping an indoor environment using 2D range data.

### BACKGROUND

Range data is often used to map an environment. For example, a range finder may be used to map the walls of an indoor environment such as a house.

An example of a surveying apparatus is disclosed in U.S. Pat. No. 8,699,005, filed by the present Applicant. The surveying apparatus includes a 2D range finder having a 2D measurement surface, whereby the 2D range finder measures a 2D data set. The surveying apparatus also including a calibrated optical imaging system coupled to the 2D range finder having calibration coefficients, whereby points from the 2D data set measured by the 2D range finder can be projected onto an image captured by the calibrated optical imaging system using the calibration coefficients.

As disclosed in U.S. Pat. No. 8,699,005, the images can be used for establishing positions and extents of walls, doorways, and windows where the map of the indoor environment is missing information. Projected and aligned 2D data sets are displayed in a floor plan window. A second window displays images captured by the imaging system. A dotted line may display the 2D data set projected onto the image in the second window using the calibration coefficients. The images can be used to fill in gaps in the 2D data set by a user observing the images in the second window and using the user input device, for example a mouse, a stylus, a touchscreen, or a touchpad, to add the missing information to the projected and aligned 2D data sets in the floor plan window.

Surveying apparatus with 2D range finders have certain limitations mapping an indoor environment. In particular, establishing positions and extents of walls, doorways, and windows by filling in missing information using the user input device may be time consuming.

Accordingly, there is a need for improved apparatus and methods relating to mapping an environment.

### SUMMARY

The following summary is intended to introduce the reader to various aspects of the applicant's teaching, but not to define any invention.

According to some aspects, there is provided a mapping system for mapping an environment, comprising a surveying apparatus, including an 2D rangefinder operable to measure at least one 2D emission pattern at an environmental surface, the at least one 2D emission pattern including range information, and at least one sensor operable to detect the at least one 2D emission pattern, and the at least one sensor including an imaging sensor operable to capture at least one image of the environmental surface, and wherein the surveying apparatus is operable to generate at least one set of configuration data indicative of an image position of the at least one image relative to the at least one 2D emission pattern; and at least one processor communicatively coupled to the surveying apparatus to receive the at least one 2D emission pattern, the at least one image, and the at least one set of configuration data, the at least one processor operable to apply an automated projection algorithm to project the at least one 2D emission pattern onto a horizontal plane to generate a map of the environment, apply an automated object recognition algorithm to the at least one image to recognize at least one feature, the at least one feature being at least one of a doorway, a mirror, and a window of the environment, apply an automated matching algorithm to the at least one image and the at least one 2D emission pattern using the at least one set of configuration data to determine a feature position of the at least one feature on the map, and mark the map to indicate the feature position of the at least one feature.

In some examples, the at least one processor is operable to apply the automated matching process to determine an extent of the at least one feature and mark the map to indicate the extent.

The at least one 2D emission pattern may include a first 2D emission pattern produced from a first location, and a second 2D emission pattern produced from a second location different from the first location, and the at least one processor may be operable to automatically align the first and second 2D emission patterns when projecting the at least one 2D emission pattern onto the horizontal plane to generate the map of the environment.

The mapping system may further comprise at least one of an electronic compass and an inertial measurement unit operable to generate a set of positional information indicative of a emission position of the 2D rangefinder, the at least one processor communicatively coupled to the surveying apparatus to receive the set of positional information and is operable to apply the set of positional information when automatically aligning the first and second 2D emission patterns.

The surveying apparatus may include an optical imaging system, the optical imaging system including the imaging sensor and an objective lens, and the at least one set of configuration data may include at least one calibration coefficient indicative of a focal length and a distortion of the objective lens, a sensor position and an orientation of the image sensor relative to the objective lens, and a lens position and an orientation of the objective lens relative to the 2D rangefinder.

The 2D rangefinder may include a laser 2D rangefinder.

The 2D rangefinder is a scanning laser rangefinder, the scanning laser rangefinder including a rangefinder sensor of the at least one sensor.

The 2D rangefinder is a triangulation laser rangefinder, the triangulation laser rangefinder including the imaging sensor.

The surveying apparatus may include a stand and a rotator, the rotator operable to rotate the 2D rangefinder and the at least one sensor relative to the stand, the rotator having a rotation axis that is substantially perpendicular to an optical axis of the imaging sensor.

The at least one 2D emission pattern may extend at least 180 degrees.

According to some aspects, there is provided a method of generating a map of an environment, comprising obtaining at least one 2D emission pattern at an environmental surface of the environment, the at least one 2D emission pattern including range information; obtaining at least one image of the environmental surface; obtaining at least one set of configuration data indicative of an image position of the at least one image relative to the at least one 2D emission pattern; generating the map of the environment by projecting the at least one 2D emission pattern onto a horizontal plane using an automated projection algorithm; identifying at least one feature in the at least one image using an automated object recognition algorithm, the at least one feature being at least one of a doorway, a mirror, and a window of the environment; identifying a feature position of the at least one feature by applying an automated matching algorithm to the at least one image and the at least one 2D emission pattern using the at least one set of configuration data; and marking the map to indicate the feature position of the at least one feature.

In some examples, the method further comprises identifying an extent of the at least one feature using the automated matching algorithm, and marking the map to indication the extent.

The at least one 2D emission pattern may include a first 2D emission pattern produced from a first location, and a second 2D emission pattern produced from a second location different from the first location, and applying the automated projection algorithm to project the at least one 2D emission pattern onto the horizontal plane to generate the map of the environment may include automatically aligning the first and second 2D emission patterns.

The method may further comprise obtaining a set of positional information from at least one of an electronic compass secured to a 2D rangefinder used to measure the at least one 2D emission pattern and an inertial measurement unit secured to the 2D rangefinder, and applying the positional information when automatically aligning the first and second 2D emission patterns.

The at least one image may be obtained from an optical imaging system, the optical imaging system including an image sensor and an objective lens, and the at least one set of configuration data including at least one calibration coefficient indicative of a focal length and a distortion of the objective lens, a sensor position and an orientation of the image sensor relative to the objective lens, and a lens position and an orientation of the objective lens relative to the a 2D rangefinder used to measure the at least one 2D emission pattern.

The at least one 2D emission pattern may be measured by a 2D laser rangefinder.

The at least one 2D emission pattern may be obtained from a scanning laser range finder.

The at least one 2D emission pattern may be obtained from a triangulation laser range finder, the triangulation laser range finder including an optical imaging system, the at least one image also obtained from the optical imaging system.

The 2D emission pattern may extend at least 180 degrees.

According to some aspects, there is provided a mapping system for mapping an environment, comprising a surveying apparatus, including an 2D rangefinder operable to measure a first 2D emission pattern at an at least one environmental surface from a first location and to measure a second 2D emission pattern at the at least one environmental surface from a second location different from the first location, each of the first and second 2D emission patterns including range information, at least one sensor operable to detect the first 2D emission pattern and the second 2D emission pattern, and the at least one sensor including an imaging sensor operable to capture at least one image of the at least one environmental surface, wherein the surveying apparatus is operable to generate at least one set of configuration data indicative of an image position of the at least one image relative to at least one of the first and second 2D emission patterns; and at least one processor communicatively coupled to the surveying apparatus to receive the first and second 2D emission patterns, the at least one image, and the at least one set of configuration data, the at least one processor operable to apply an automated object recognition process to the at least one image to recognize at least one feature, the at least one feature being at least one of a doorway, a mirror, and a window of the environment, apply an automated matching process using the at least one set of configuration data to determine a feature position of the at least one feature relative to the at least one of the first and second 2D emission patterns, automatically align the first and second 2D emission patterns using the feature position to identify an overlap in the first and second 2D emission patterns, and apply an automated projection process to project the aligned first and second 2D emission patterns onto a horizontal plane to generate the map of the environment.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a schematic diagram of a mapping system in an environment

FIG. 2A is a schematic diagram of a 2D emission pattern projected onto a horizontal surface;

FIG. 2B is a schematic diagram of an image with the 2D emission pattern of FIG. 2A projected onto the image;

FIG. 3A is a schematic diagram of a first 2D emission pattern;

FIG. 3B is a schematic diagram of a second 2D emission pattern;

FIG. 3C is a schematic diagram of the first and second 2D emission patterns aligned; and

FIG. 4 is flow chart of a method of generating a map of an environment.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses or process described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim, or dedicate to the public any such invention by its disclosure in this document.

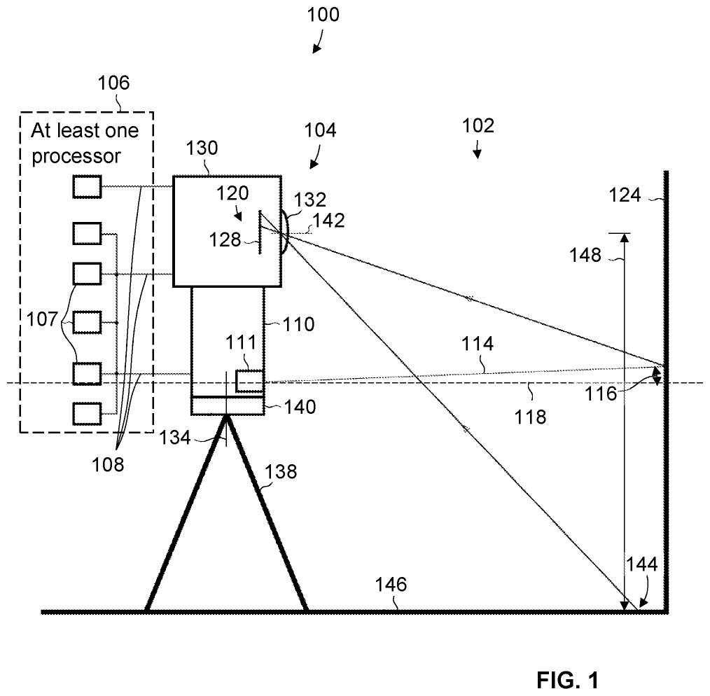

Referring to FIG. 1, illustrated therein is an example of a mapping system 100 for mapping an environment 102. For example, the mapping system 100 may be used for mapping an indoor environment, such as a layout of one or more rooms or spaces of a building. In some examples, the mapping system 100 performs a geometric instrument function and/or an optical measuring function.

In some examples, the mapping system 100 allows surveying data to be captured quickly at a field site to be post-processed and analyzed and/or dynamically processed and analyzed, such as used to generate a map and/or floor plan, elsewhere. In some examples, the mapping system 100 is provided to capture image data, such as for documenting a site in a way that the image data can be correlated with surveying data and/or a map or floor plan. For example, the mapping system 100 may accurately record an imaging location and an imaging direction from which the image was taken.

The example mapping system 100 may be used for real estate or insurance applications to generate a floor plan and images of a property, such as for use in creating a virtual tour. The mapping system 100 may be used to document images and a floor plan of a crime scene and make subsequent measurements using the documentation. The mapping system 100 may be used for construction industry applications to document structural elements of a building at various construction stages, such as documenting a house frame with embedded wiring before drywall is installed.

The illustrated example mapping system 100 includes a surveying apparatus 104 and at least one processor 106 communicatively coupled to the surveying apparatus 104. The illustrated at least one processor 106 includes a plurality of processors 107.

In some examples, the at least one processor 106 is communicatively coupled to the surveying apparatus 104 wirelessly. In some examples, the at least one processor 106 is communicatively coupled to the surveying apparatus 104 by one or more wired connections in addition to or in alternative to one or more wireless connections. In the illustrated example, the at least one processor 106 is communicatively coupled to the surveying apparatus 104 through a wired network 108.

The illustrated example surveying apparatus 104 includes an 2D rangefinder 110 operable to measure at least one 2D emission pattern 114 at an environmental surface 124, the at least one 2D emission pattern including range information. For example, the 2D rangefinder 110 may measure angular position and distance dimensions. In some examples, the 2D rangefinder 110 is a laser 2D rangefinder including a laser source 111.

The use of a 2D rangefinder is advantageous over, for example, a 3D rangefinder. For example, a 3D laser scanner may be used to generate a 3D point cloud and may include a camera for capturing image or texture data to be overlaid on the 3D point cloud. In some cases, a 2D slice may be extracted from a 3D point cloud and used to draw a floor plan. However, the amount of data captured by a 3D laser scanner may be excessive, the time required to capture a 3D scan of a room may be a few minutes or otherwise excessively long, and the cost of a 3D laser scanner may be more expensive than a 2D rangefinder.

The 2D rangefinder 110 may be operable to measure the at least one 2D emission pattern 114 across a predetermined angular extent, such as at least 90 degrees, at least 180 degrees, or at least 360 degrees. The 2D rangefinder 110 may be operable to measure a 2D emission pattern as a horizontal pattern or at an angle 116 to the horizontal 118.

The example surveying system 104 includes the 2D rangefinder 110 and at least one sensor 120 operable to detect the 2D emission pattern 114.

The 2D rangefinder 110 may be operable to measure more than one emission pattern, such as measuring a first pattern from a first location and a second pattern from a second, different location, as described further below.

Each 2D emission pattern 114 may include a plurality of points, and the range information may be indicative of the distance from the surveying apparatus 104 to the at least one environmental surface 124 at each point in the emission pattern.

In the illustrated example, the at least one sensor 120 includes an imaging sensor 128. The imaging sensor 128 is operable to capture at least one image of the at least one environmental surface 124.

The imaging sensor 128 may be part of an optical imaging system 130. For example, the optical imaging system 130 may include the imaging sensor 128 and an objective lens 132. The objective lens 132 may be a panoramic objective lens with a field of view of at least 180 degrees. A panoramic objective lens may allow complete coverage of 360 degrees using just two shots by rotating the imaging sensor by 180 degrees around a rotational axis 134 between shots. In some examples, the images can be projected onto sides of a cube to produce six rectified images. In some examples, three shots spaced 120 degrees apart may be used to increase the resolution of a rectified image, as the resolution of the rectified image may be low at the edges of the field of view of the lens. In some examples, the optical imaging system 130 is above the 2D rangefinder 110, such as to avoid obstruction of a wide angle panoramic view above a panoramic lens.

In some examples, the imaging sensor 128 is operable to generate High Dynamic Range (HDR) images and/or use similar techniques based on combining multiple mages taken at different exposures into a resulting image with equalized intensity distribution. For example, such images may be taken in indoor environments, which often include bright areas, such as near windows, and dark areas, such as in corners.

The illustrated example surveying apparatus 104 is also operable to generate at least one set of configuration data. The at least one set of configuration data is indicative of an image position of the at least one image relative to the at least one 2D emission pattern 114. For example, the set of configuration data may include information about the distance from the imaging sensor 128 to the 2D rangefinder 110 and/or the orientation of one or both of the imaging sensor 128 and the 2D rangefinder 110.

In some examples the at least one set of configuration data includes at least one calibration coefficient indicative of a focal length and a distortion of the objective lens 132, a sensor position and an orientation of the imaging sensor 128 relative to the objective lens 132, and a lens position and an orientation of the objective lens 132 relative to the 2D rangefinder 110. For example, calibration coefficients may be determined using a method of sensor calibration, such as by imaging a pattern of known geometry from a plurality of poses using the at least one sensor 120, and matching the resulting information to determine the at least one sensor's position and orientation. Further calibration methods are discussed in U.S. Pat. No. 8,699,005.

The 2D rangefinder 110 may include a sensor of the at least one sensor 120. The 2D rangefinder may be an instrument that measures a distance from itself to points on surfaces of objects in three dimensional (3D) space. For example, for a given 2D data set the 2D rangefinder may measure distances to at least one environmental surface along a set of straight measurement lines, all of the measurement lines being in a plane in 3D space and the direction of each line known or knowable from the measurement.

In some examples, the imaging sensor 128 is not used as part of the 2D rangefinder of the surveying apparatus 104. For example, the surveying apparatus 104 may include a scanning laser rangefinder using a time of flight of a laser pulse to measure range. The at least one sensor 120 may include a rangefinder sensor in addition to the imaging sensor 128, and the scanning laser rangefinder may include the rangefinder sensor.

However, in some examples, the imaging sensor 128 is used as part of the 2D rangefinder. For example, the surveying apparatus may include a triangulation laser rangefinder. The triangulation laser rangefinder may include the imaging sensor 128. For example, the triangulation laser rangefinder may include a laser source rotationally mounted relative to the imaging sensor 128 to generate a laser emission that is swept at least once across the field of view of the imaging sensor during an exposure time of the imaging sensor 128. The position of the imaged laser line on the at least one image may be used to detect the at least one 2D emission pattern 114 with range information.

In some examples, the 2D emission pattern of the laser 2D rangefinder is formed by at least one laser with line generating optics, for example with a Powell lens. In some examples, a fan angle of the line generating optics may be equal to or greater than the field of view of an objective lens of an optical imaging system that includes the imaging sensor, such as to enable surveying the largest area possible. In some examples, more than one laser with line generating optics is used, with the lasers arranged to cover the field of view of the objective lens such that the sum of the fan angles of all the line generating optical elements is equal to or greater than the field of view of the objective lens. For example, more than one laser with line generating optics may be used to comply with design constraints, such as possible regulatory limitations on the power of a single laser taken together with a desired intensity of the laser line.

In the illustrated example, the surveying apparatus 100 includes a stand 138 and a rotator 140. The rotator 140 is operable to rotate the 2D rangefinder 110 and the at least one sensor 120 relative to the stand 138. The rotator 140 has a rotational axis 134 that is substantially perpendicular to an optical axis 142 of the imaging sensor 128. The rotator 140 may be a panoramic rotator. The rotator may be used to minimize deviations of the rotational axis 134 from a vertical orientation and/or to enable repeatable rotation into predetermined positions.

In some examples, the rotator 140 enables the 2D rangefinder 110 and the at least one sensor 120 to be repeatedly rotated between predetermined angular positions relative to the stand 138. For example, the predetermined angular positions may include a set of two positions spaced 180 degrees apart or a set of three positions spaced 120 degrees apart.

In some examples, the surveying apparatus 100 includes more than one optical imaging system 130, so as to not have a need to rotate the apparatus in order to produce a complete spherical image of the environment and the multiple optical imaging systems 130 can be parts of a 360 degree camera, such a Insta 360 or Ricoh Theta cameras.

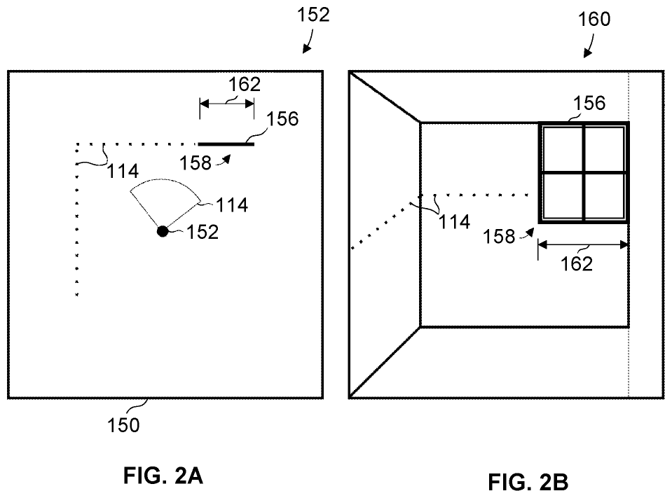

In some examples, the mapping system 100 includes an inertial measurement unit operable to generate a set of positional information indicative of the emission position 154 (FIG. 2A) of the 2D rangefinder 110. In some examples, the inertial measurement unit measures changes in position and orientation, such as measuring any changes in position and orientation of the 2D rangefinder 110 between measuring a first 2D emission pattern and measuring a second 2D emission pattern. Positional information may be used to assist in aligning first and second 2D emission patterns.

In some examples, the mapping system 100 includes an electronic compass operable to generate a set of positional information indicative of an emission position of the 2D rangefinder 110. For example, the electronic compass may be integrated into an inertial measurement unit to improve the accuracy of the inertial measurement unit.

In some examples, the mapping system 100 is operable to measure a floor point 144 on a floor 146 by triangulation using images captured by the imaging sensor 128, configuration information about the imaging sensor 128, and information about an imaging height 148 from the floor. A floor point 144 may be useful for marking the position of something on a map or floor plan, such as to mark a position for a forensic science application.

Referring now to FIGS. 2A and 2B, the illustrated example at least one processor 106 is communicatively coupled to the surveying apparatus 104 to receive the at least one 2D emission pattern 114, the at least one image, and the at least one set of configuration data. In some examples, the at least one processor 106 is operable to apply an automated projection algorithm to project the at least one 2D emission pattern 114 onto a horizontal plane 150 to generate a map 152 of the environment. In some examples, the map 152 is a floor plan, such as a floor plan of an indoor environment.

For example, the at least one processor 106 may be operable to apply a Simultaneous Localization and Mapping (SLAM) algorithm to build a 2D point map. In another example, projecting the at least one 2D emission pattern may include using a set of tilt information. The set of tilt information may include the angle 116 between the 2D emission pattern and the horizontal 118. In some examples, this angle 116 is determined using gravity and a bubble level coupled to the 2D rangefinder 110. In some examples, an accelerometer may be used if 2D rangefinder 110 is static, or an inertial measurement unit may be used if the 2D rangefinder 110 is in motion. In some examples, an assumed set of tilt information may be used instead of a measured set of tilt information. Tilt information along with the range information may be used to project the at least one 2D emission pattern 114 onto a horizontal plane to generate a map and/or floor plan.

Projected and aligned 2D emission patterns may be displayed to a user to allow a user to manually add detail from an image to a floor plan or map, as described in U.S. Pat. No. 8,699,005. However, in some examples the at least one processor 106 is also operable to apply an automated object recognition algorithm to the at least one image to recognize at least one feature 156. The at least one feature 156 may be at least one of a doorway, a mirror, and a window of the environment. In some examples, the at least one processor 106 is also operable to apply an automated matching algorithm to the at least one image and the at least one 2D emission pattern using the at least one set of configuration data to determine a feature position 158 of the at least one feature 156 on the map 152.

For example, reflective surfaces such as glass windows or mirrors may cause ghost data as an emission beam is reflected. Identifying a window or mirror may be difficult, as the ghost data may appear to the at least one sensor the same as the rest of a 2D emission pattern. If a window or a mirror could be identified in the at least one image 160 and the position of the at least one image 160 relative the at least one 2D emission pattern 114 is known, the part of the at least one 2D emission pattern 114 that spans the window or mirror may be determined. For example, it may be removed from the at least one 2D emission pattern to make aligning the at least one 2D emission pattern with another 2D emission pattern easier.

Identifying an object may be done, for example, by an artificial intelligence (AI) algorithm or other matching algorithm. The algorithm may detect and classify an object in the at least one image 160. The algorithm may also be able identify the location and extent of the object in the at least one image 160. Automatic detection of doorways, windows, and mirrors in the at least one image 160 and consequently in the at least one 2D emission pattern 114 may improve the speed and accuracy of mapping.

In some examples, the at least one processor 106 is operable to automatically mark the map to indicate the feature position 158 of the at least one feature 156. Marking the map may include removing a line or adding an indicator, such as removing a line to indicate that a wall is broken by a window or doorway or adding a schematic window, mirror, or doorway.

In some examples, the at least one processor 106 is operable to automatically compare a map or floor plan to a known feature position and/or extent to verify that the map or floor plan includes the feature position and/or extent. For example, the at least one processor 106 may be operable to generate a warning if the map or floor plan is missing the feature position.

In some examples, the at least one processor 106 is operable to automatically identify a room type using object recognition and the at least one image 160, such as by recognizing a doorway, a window, or a mirror, or by recognizing further room objects, such as a bed, tub, or sink. The room type may be marked on a map or floor plan. For example, the at least one processor 106 may be operable to automatically identify a room type and add a label indicating the room type to a map or floor plan.

In some examples, the at least one processor 106 is also operable to apply the automated matching process to determine an extent 162 of the at least one feature 156 and mark the map to indicate the extent 162.

In some examples, the at least one processor 106 is communicatively coupled to the surveying apparatus 104 to receive the set of positional information generated by the inertial measurement unit and/or electronic compass, and is operable to apply the set of positional information in aligning first and second 2D emission patterns.

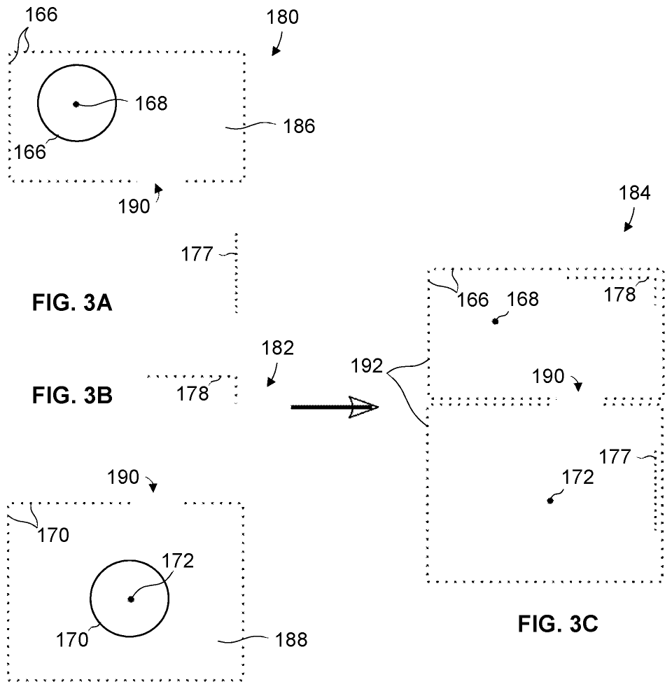

Referring now to FIGS. 3A to 3C, in some examples the 2D rangefinder 110 is operable to measure a first 2D emission pattern 166 from a first location 168 and to measure a second 2D emission pattern 170 from a second location 172 different from the first location 168. A first projection 180 and a second projection 182 may be aligned to form a combined projection 184.

In some examples, the at least one sensor 120 is operable to detect the first 2D emission pattern 166 at the least one environmental surface 124. The at least one sensor 120 is also operable to detect the second 2D emission pattern 170 at the at least one environmental surface 124. Each of the first 2D emission pattern 166 and the second 2D emission pattern 170 includes range information.

The surveying apparatus 104 is operable to generate at least one set of configuration data indicative of an image position of the at least one image relative to at least one of the first 2D emission pattern 166 and second 2D emission pattern 170.

For example, the surveying apparatus 104 may be repositioned to measure a second 2D emission pattern 170. In some examples, the second location 172 is chosen so that the first 2D emission pattern 166 and the second 2D emission pattern 170 have at least one overlap. In the illustrated example the first 2D emission pattern 166 includes a first overlap portion 177 overlapping with the second 2D emission pattern 170. The second 2D emission pattern 170 includes a second overlap portion 178 overlapping with the first 2D emission pattern 166.

In some examples, the at least one processor 106 is operable to automatically align the first 2D emission pattern 166 and the second 2D emission pattern 170 when projecting the at least one 2D emission pattern 114 onto the horizontal plane 150 to generate the map 152 of the environment. For example, the at least one processor 106 may apply an automated aligning algorithm.

In the illustrated example, the first location 168 is in a first room 186, and the second location 172 is in a second room 188 that is adjoining the first room 186, with an open doorway 190 between the rooms. In the illustrated example, an alignment of the first 2D emission pattern 166 and the second 2D emission pattern 170 may include minimizing a suitable cost function, for example, distances between the closest common points, to generate the aligned 2D emission pattern 192. Various suitable scan alignment algorithms can be used; for example, an Iterative Closest Point (ICP) algorithm. The aligned 2D emission pattern 192 may be projected onto a horizontal plane and brought into a common coordinate system.

In some examples, the aligned 2D emission pattern 192 is generated and/or projected onto a horizontal plane dynamically and automatically as new measurements are taken by the surveying apparatus 104. For example, the Simultaneous Localization and Mapping (SLAM) algorithm may be used to dynamically and automatically build a map from 2D data as the surveying apparatus is carried from room to room in a building. In some examples, the surveying apparatus for dynamic updating includes a high frame rate optical imaging system and a high acquisition rate rangefinder.

In some examples, the at least one processor 106 is operable to apply an automated matching process using the at least one set of configuration data to determine the feature position 158 of the at least one feature 156 relative to the at least one of the first 2D emission pattern 166 and the second 2D emission pattern 170.

In some examples, the at least one processor 106 is operable to automatically align the first 2D emission pattern 166 and the second 2D emission pattern 170 using the feature position 158 to identify an overlap 177, 178 in the first 2D emission pattern 166 and the second 2D emission pattern 170.

For example, mapping algorithms based only on 2D emission patterns may have difficulties in aligning 2D emission patterns to build a map. When the first 2D emission pattern 166 is taken from the first room 186 and the second 2D emission pattern 170 is taken form the second adjoining room 188 with an open doorway 190 in between, the portion of each 2D emission pattern taken though the open doorway 190 may be a small percentage of the entire 2D emission pattern. It may be difficult for an algorithm to identify the doorway in the 2D emission pattern data.

However, if the doorway 190 is identified in the at least one image 160 the part of the 2D emission pattern data taken through the open doorway 190 may be more easily identified. The identified overlap 177, 178 may then be used to align the first 2D emission pattern 166 and the second 2D emission pattern 170.

In some examples, object identification may be used to identify a position and an extent of the doorway 190, and the position and the extent may be used to identify the overlap 177, 178. The overlap 177, 178 may be used to generate an initial guess for alignment. Photogrammetry techniques may be used to generate the initial guess. In some examples, the initial guess allows other automated alignment algorithms to converge faster.

In some examples, the at least one processor 106 is operable to apply an automated projection process to project the first 2D emission pattern 166 and the second 2D emission pattern 170, aligned, onto a horizontal plane to generate the map 152 of the environment 102.

In some examples, a map 152 or floor plan may be provided to a user, such as by transmitting the map 152 or floor plan through a wired or wireless connection to a screen of a netbook or tablet for real time visual assessment of site coverage and image quality. In some examples, a user can also control the position and/or orientation of the surveying apparatus 104, such as by remote control through the netbook or tablet.

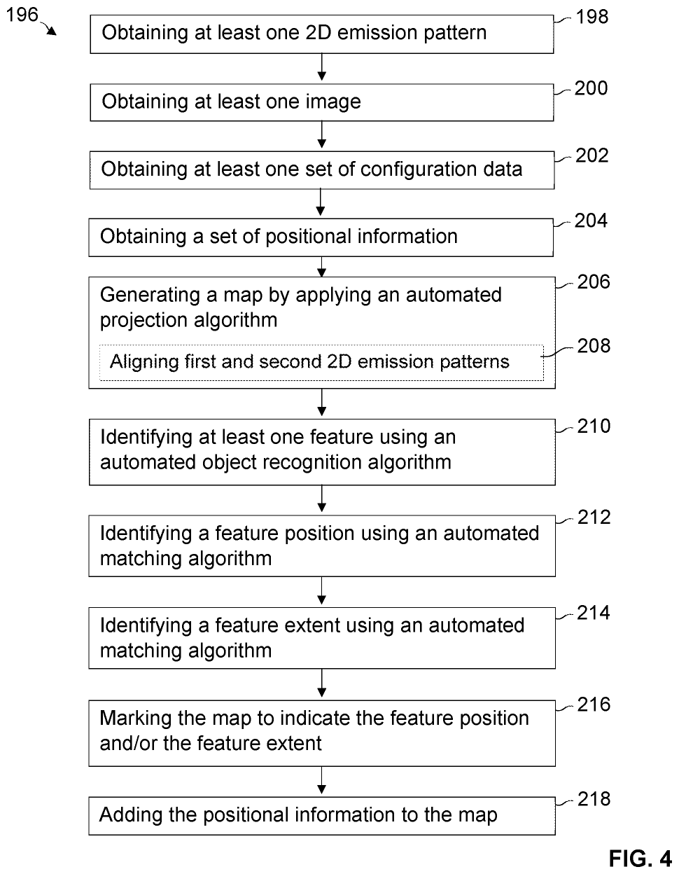

Referring now to FIG. 4, illustrated is an example of a method 196 of generating a map of an environment. The illustrated example method 196 includes, at step 198,—obtaining at least one 2D emission pattern at an environmental surface of the environment, the at least one 2D emission pattern including range information.

The 2D rangefinder may include a laser 2D rangefinder. In some examples, the at least one 2D emission pattern is obtained from a scanning laser range finder. In some examples, the at least one 2D emission pattern is obtained from a triangulation laser range finder, the triangulation laser range finder including an optical imaging system. In some examples, the optical imaging system of the triangulation laser range finder is also used to generate at least one image as described below, and the at least one image is obtained from the optical imaging system.

The illustrated example method 196 includes, at step 200, obtaining at least one image of the environmental surface. In some examples, the at least one image is obtained from an optical imaging system. The optical imaging system may include an image sensor and an objective lens, and the at least one set of configuration data including at least one calibration coefficient indicative of a focal length and a distortion of the objective lens, a sensor position and an orientation of the image sensor relative to the objective lens, and a lens position and an orientation of the objective lens relative to the 2D rangefinder. The optical image sensor may be used as part of the triangulation laser range finder if the 2D rangefinder is a triangulation laser range finder.

The illustrated example method 196 includes, at step 202, obtaining at least one set of configuration data indicative of an image position of the at least one image relative to the at least one 2D emission pattern.

In some examples, the method 196 includes at step 204, obtaining a set of positional information. For example, the set of positional information may be obtained from an electronic compass secured to the 2D rangefinder or an inertial measurement unit secured to the 2D rangefinder.

The illustrated example method 196 includes at step 206, generating the map of the environment by projecting the at least one 2D emission pattern onto a horizontal plane using an automated projection algorithm.

In some examples, the at least one 2D emission pattern includes a first 2D emission pattern produced from a first location and a second 2D emission pattern produced from a second location different from the first location. In some examples, the method 196 includes, at step 206, applying the automated projection algorithm to project the at least one 2D emission pattern onto the horizontal plane to generate the map of the environment and at step 208, automatically aligning the first and second 2D emission patterns.

In some examples, the method 196 includes applying the set of positional information in aligning the first and second 2D emission patterns.

In the illustrated example, the method 196 includes at step 210, identifying at least one feature in the at least one image using an automated object recognition algorithm, the at least one feature being at least one of a doorway, a mirror, and a window of the environment.

The illustrated example method 196 includes at step 212, identifying a feature position of the at least one feature by applying an automated matching algorithm to the at least one image and the at least one 2D emission pattern using the at least one set of configuration data.

In some examples, the method 196 includes applying the feature position of the at least one feature in aligning the first and second 2D emission patterns.

In some examples, the method 196 includes at step 214, identifying an extent of the at least one feature using the automated matching algorithm.

The illustrated example method 196 includes, at step 216, marking the map to indicate the feature position of the at least one feature. Marking the map may include removing a line or adding an indicator, such as removing a line to indicate that a wall is broken by a window or doorway or adding a schematic window, mirror, or doorway.

In some examples, the method 196 includes at step 218, marking the map to indication the extent.

The present invention has been described here by way of example only. Various modification and variations may be made to these examples without departing from the scope of the invention, which is limited only by the appended claims.

1. A mapping system for mapping an environment, comprising:
a surveying apparatus, including:
an 2D rangefinder operable to measure at least one 2D emission pattern at an environmental surface, the at least one 2D emission pattern including range information, and
at least one sensor operable to detect the at least one 2D emission pattern, and the at least one sensor including an imaging sensor operable to capture at least one image of the environmental surface, and
wherein the surveying apparatus is operable to generate at least one set of configuration data indicative of an image position of the at least one image relative to the at least one 2D emission pattern; and
at least one processor communicatively coupled to the surveying apparatus to receive the at least one 2D emission pattern, the at least one image, and the at least one set of configuration data, the at least one processor operable to:
apply an automated projection algorithm to project the at least one 2D emission pattern onto a horizontal plane to generate a map of the environment,
apply an automated object recognition algorithm to the at least one image to recognize at least one feature, the at least one feature being at least one of a doorway, a mirror, and a window of the environment,
apply an automated matching algorithm to the at least one image and the at least one 2D emission pattern using the at least one set of configuration data to determine a feature position of the at least one feature on the map, and
mark the map to indicate the feature position of the at least one feature.

2. The mapping system of claim 1, wherein the at least one processor is operable to apply the automated matching process to determine an extent of the at least one feature and mark the map to indicate the extent.

3. The mapping system of claim 1, wherein:
the at least one 2D emission pattern includes:
a first 2D emission pattern produced from a first location, and
a second 2D emission pattern produced from a second location different from the first location, and
the at least one processor is operable to automatically align the first and second 2D emission patterns when projecting the at least one 2D emission pattern onto the horizontal plane to generate the map of the environment.

4. The mapping system of claim 3, further comprising at least one of an electronic compass and an inertial measurement unit operable to generate a set of positional information indicative of a emission position of the 2D rangefinder, the at least one processor communicatively coupled to the surveying apparatus to receive the set of positional information and operable to apply the set of positional information when automatically aligning the first and second 2D emission patterns.

5. The mapping system of claim 1, wherein the surveying apparatus includes an optical imaging system, the optical imaging system including the imaging sensor and an objective lens, and the at least one set of configuration data includes at least one calibration coefficient indicative of a focal length and a distortion of the objective lens, a sensor position and an orientation of the image sensor relative to the objective lens, and a lens position and an orientation of the objective lens relative to the 2D rangefinder.

6. The mapping system of claim 1, wherein the 2D rangefinder includes a laser 2D rangefinder.

7. The mapping system of claim 6, wherein the 2D rangefinder is a scanning laser rangefinder, the scanning laser rangefinder including a rangefinder sensor of the at least one sensor.

8. The mapping system of claim 6, wherein the 2D rangefinder is a triangulation laser rangefinder, the triangulation laser rangefinder including the imaging sensor of the at least one sensor.

9. The mapping system of claim 1, wherein the surveying apparatus includes a stand and a rotator, the rotator operable to rotate the 2D rangefinder and the at least one sensor relative to the stand, the rotator having a rotation axis that is substantially perpendicular to an optical axis of the imaging sensor.

10. The mapping system of claim 1, wherein the at least one 2D emission pattern extends at least 180 degrees.

11. A method of generating a map of an environment, comprising:
obtaining at least one 2D emission pattern at an environmental surface of the environment, the at least one 2D emission pattern including range information;
obtaining at least one image of the environmental surface;
obtaining at least one set of configuration data indicative of an image position of the at least one image relative to the at least one 2D emission pattern;
generating the map of the environment by projecting the at least one 2D emission pattern onto a horizontal plane using an automated projection algorithm;
identifying at least one feature in the at least one image using an automated object recognition algorithm, the at least one feature being at least one of a doorway, a mirror, and a window of the environment;
identifying a feature position of the at least one feature by applying an automated matching algorithm to the at least one image and the at least one 2D emission pattern using the at least one set of configuration data; and
marking the map to indicate the feature position of the at least one feature.

12. The method of claim 11, further comprising:
identifying an extent of the at least one feature using the automated matching algorithm, and
marking the map to indication the extent.

13. The method of claim 11, wherein:
the at least one 2D emission pattern includes:
a first 2D emission pattern produced from a first location, and
a second 2D emission pattern produced from a second location different from the first location, and
applying the automated projection algorithm to project the at least one 2D emission pattern onto the horizontal plane to generate the map of the environment including automatically aligning the first and second 2D emission patterns.

14. The method of claim 14, further comprising:
obtaining a set of positional information from at least one of an electronic compass secured to a 2D rangefinder used to measure the at least one 2D emission pattern and an inertial measurement unit secured to the 2D rangefinder, and
applying the positional information when automatically aligning the first and second 2D emission patterns.

15. The method of claim 11, wherein the at least one image is obtained from an optical imaging system, the optical imaging system including an image sensor and an objective lens, and the at least one set of configuration data including at least one calibration coefficient indicative of a focal length and a distortion of the objective lens, a sensor position and an orientation of the image sensor relative to the objective lens, and a lens position and an orientation of the objective lens relative to a 2D rangefinder used to measure the at least one 2D emission pattern.

16. The method of claim 11, wherein the at least one 2D emission pattern is measured by a 2D laser rangefinder.

17. The method of claim 16, wherein the at least one 2D emission pattern is obtained from a scanning laser range finder.

18. The method of claim 16, wherein the at least one 2D emission pattern is obtained from a triangulation laser range finder, the triangulation laser range finder including an optical imaging system, the at least one image also obtained from the optical imaging system.

19. The method of claim 11, wherein the 2D emission pattern extends at least 180 degrees.

20. A mapping system for mapping an environment, comprising:
a surveying apparatus, including:
an 2D rangefinder operable to measure a first 2D emission pattern at an at least one environmental surface from a first location and to measure a second 2D emission pattern at the at least one environmental surface from a second location different from the first location, each of the first and second 2D emission patterns including range information,
at least one sensor operable to detect the first 2D emission pattern and the second 2D emission pattern, and the at least one sensor including an imaging sensor operable to capture at least one image of the at least one environmental surface,
wherein the surveying apparatus is operable to generate at least one set of configuration data indicative of an image position of the at least one image relative to at least one of the first and second 2D emission patterns; and
at least one processor communicatively coupled to the surveying apparatus to receive the first and second 2D emission patterns, the at least one image, and the at least one set of configuration data, the at least one processor operable to:
apply an automated object recognition process to the at least one image to recognize at least one feature, the at least one feature being at least one of a doorway, a mirror, and a window of the environment,
apply an automated matching process using the at least one set of configuration data to determine a feature position of the at least one feature relative to the at least one of the first and second 2D emission patterns,
automatically align the first and second 2D emission patterns using the feature position to identify an overlap in the first and second 2D emission patterns, and
apply an automated projection process to project the aligned first and second 2D emission patterns onto a horizontal plane to generate the map of the environment.
